(19) United States
(12) Patent Application Publication
(10) Pub. No.: US 2008/0125014 A1
(43) Pub. Date: May 29, 2008

(54) Sub-aperture deterministric finishing of high aspect ratio glass products

(76) Inventors: William Rogers Rosch, Corning, NY (US); Robert Sabia, Corning, NY (US)

Correspondence Address: CORNING INCORPORATED, SP-TI-3-1, CORNING, NY, 14831, US

(21) Appl. No.: 11/605,640

(22) Filed: Nov. 29, 2006

(51) Int. Cl. B24B 49/12; B24B 51/00; G02F 1/00

(52) U.S. Cl. 451/5; 451/6; 451/41; 451/29; 451/57; 349/110

(57) ABSTRACT

The invention is directed to large LCD image masks having a final flatness of less than 40 nm and a method of making such LCD image masks by utilizing subaperture deterministic grinding/lapping/polishing. In one preferred embodiment the final flatness is <20 μm. In another the final flatness is <10 nm. The LCD image masks have a length and width that are each, independently of the other, greater than 400 mm and a thickness that is less than 20 mm. In at least one preferred embodiment the ICD image masks have a length and width that are each, independently, greater than 100 mm and the thickness is <15 mm. The glass LCD image masks can be of any glass materials suitable for LCD image masks. The method of the invention can be used with all such glasses. Exemplary LCD image mask glasses include fused silica, high purity fused silica and silica-titania containing 5-10 wt. % titania.

### FIELD OF THE INVENTION

The invention is directed to a method of manufacturing LCD (“liquid crystal display’) image masks that meet a flatness requirement of less than 40 μm; and in particular the invention is directed to manufacturing high aspect ratio LCD image masks.

### BACKGROUND OF THE INVENTION

The task of obtaining the flatness required for LCD mask is difficult to achieve; particularly in comparison to IC (“integrate circuit”) masks. In the case of LCD masks the problem of obtaining a sub-40 μm flatness specification is compounded by the aspect ratio of the part and the amount of bow or warp it experiences due to its own weight and geometry. For example, for a standard IC mask of fused silica with dimensions of 152.4×152.4×6.35 mm, the mask sees a maximum deflection of 0.18 μm when held horizontally by its edges (see FIG. 1). In comparison, a fused silica LCD image mask with dimensions of 1220×1400×13 mm (1846 mm diagonal) sees a maximum deflection of nearly 240 μm when held in the same manner (see FIG. 2).

For the IC mask exemplified above, attaining a specified flatness in the range of 0.5-1.0 μm is a relatively simple issue of conforming the part to a worktable of equal or higher flatness, and uniformly removing material. The back-side support surface does not need to have the flatness of the worktable due to limited deformation of the part during processing. Any non-uniform surface/subsurface damage and related stresses do not significantly act to deform the part due to its aspect ratio being relatively low and the part thus being relatively stiff.

In contrast to the IC mask, the extreme aspect ratio of the LCD image mask described above (e.g., an aspect ratio of 140/1, 1846 mm diagonal) can impact the process of attaining the specified flatness due in part to deflection during grinding, lapping, and polishing. If the back-side support surface is not flat, the part will conform to that surface and uniform material removal will not be achieved no matter how flat the worktable itself may be. As a result of non-uniform material removal, surface/subsurface damage (along with stresses incurred in the part as a result of surface/subsurface damage) is typically not uniform across the part and results in additional deformation due to the fact that the part is so thin that is can bow to alleviate these stresses.

As a result, the standard approach for attaining sub-40 μm flatness for high aspect ratio parts such as LCD image masks is to single-side lap on large planetary tables, allowing the part to rest under its own weight and promoting higher material removal at locations of higher stress (initial contact locations dictated by the part's initial geometry). However, this process is exceedingly slow and offers no means for correction of parts that do not meet specification after initial processing. Conversely, double-side lapping and polishing can be employed but limits attainable flatness due to the part being pressed flat during abrasive material removal, subsequently imparting a non-uniform stress across the part to maintain part contact with the table, with the lapped/polished surface resulting in “springback” once the part is removed from the table.

Although the industry standard for LCD flatness is sub-40 μm, there is a target for the production of final polished flatness levels of 10-20 μm. Since flatness is lost during polishing, a ready-for-polish flatness target of 2-10 μm is desired to enable a manufacturer to attain the 10-20 μm final flatness target. The present invention is directed to a method for producing image masks having a final flatness in the 10-20 μm range of sub-aperture deterministic polishing, lapping and grinding.

### SUMMARY OF THE INVENTION

In one aspect the invention is directed to a method for manufacturing LCD image masks having a final finished flatness of less than 40 μm. In one embodiment, the invention is directed to LCD image masks having a flatness in the 10-20 μm range. To attain the final polished flatness of 10-20 μm, the method is further directed to manufacturing LCD image masks that have a ready-to-polish flatness in the of 2-10 μm.

The method of the invention is further directed to the use of an optical non-contact instrument that measures the flatness of LCD image masks up to 1200×1400 mm in size and 8-13 mm in thickness. In a preferred embodiment the optical non-contact instrument is a laser interferometer. After measurement, the LCD image mask is ground, lapped and polished as necessary using a CNC (“computer numerical controlled”) instrument that utilizes the interferometric data to grind, lap and polish the surface of the LCD mask to remove high spot and other imperfections to form a LCD image mask surface having a final finished flatness of <40 μm. In preferred embodiments the LCD image mask surface has a flatness in the range of 2-10 μm before final finishing (that is, before any grinding, lapping and polishing) and final finished flatness of <20 μm. In one particular embodiment the final finished flatness is in the range of 10-20 μm. In another embodiment the final finished flatness is <10 μm.

In a further aspect the invention is directed to a method of making very large LCD image masks having a final finished flatness of <40 μm, the method having at least the steps of obtaining a glass article having a length, a width and a thickness suitable for making LCD image masks, wherein the article has a first or front face and a second or back face; suspending the article in the vertical position so that it own weight does not bend the article; imaging both the first and the second face using an optical interferometer and storing the imaging data in algorithmic form; placing the glass article on a flat table with the first face in the upward or top position and the second face is in contact with the table and holding the article in place by its own weight or preferably by application of vacuum to the second or bottom face; grinding/lapping/polishing in a surface profile as calculated by use of the interferometric date obtained for both faces such that the first face, after grinding/lapping/polishing and release from the table, and being re-suspended in the vertical position, has a first face that is flat as may optionally be determined by interferometry. The glass article is then returned to the flat table, this time with the first face in contact with the flat table and second face in the top position, and the article is then again held in place by its own weight or preferably by application of vacuum to the first face; grinding/lapping/polishing the second face in a surface profile as calculated by use of the interferometric data obtained for both faces such that the second face, after grinding/lapping/polishing and release from the table, and being re-suspended in the vertical position, has a second face that is also flat. After both the first and second faces have been ground/lapped/polished, the faces are interferometrically rescanned to determine the flatness of the first and second faces. If sufficient flatness has not been achieved then the steps can be repeated using the new interferometric data to achieve the target degree of flatness. Application of the method of the invention results in a glass LCD image mask having a final flatness of <40 μm. In one preferred embodiment the final flatness is <20 μm. In yet another embodiment the final flatness is <10 μm.

The invention is also directed to LCD image masks having a length, width and thickness of which the length and width are each, independently of the other, greater than 400 mm and the thickness is less than 20 mm. In one embodiment the length and width is each, independently, greater then 800 mm. In a further embodiment the length and width is each, independently, greater than 1000 mm. In another embodiment the length and width is each, independently, greater then 1200 mm. In further embodiments the thickness of the LCD image mask is less then 15 mm. In additional embodiments the thickness is less than 10 mm. In all the foregoing embodiments the LCD image masks of the invention have final flatness of >40 nm, preferably <20 nm. In yet another embodiment the foregoing LCD image masks have a final flatness of <10 nm. Any glass suitable for LCD image masks can be used in practicing the invention. Preferred glasses are fused silica glass, high purity fused silica glass and silica-titania glass containing 5-10 wt. % titania. An example of high purity fused silica glass is a glass meeting or substantially meeting the specifications of the HPFS® brand high purity fused silica sold by Corning Incorporated.

### BRIEF DESCRIPTION OF THE DRAWINGS

FIG. 1 illustrates the calculated warpage that is incurred by a fused silica IC mask, size 152.4×152.4×6.35 mm, held horizontal by its edges.

FIG. 2 illustrates the calculated warpage incurred by a 1220×1400×13 mm fused silica LCDIC mask held horizontal by its edges.

FIGS. 3a-3d is a schematic of the LCD image mask processing using a sub-aperture, deterministic tool.

### DETAILED DESCRIPTION OF THE INVENTION

The invention is directed to LCD image masks and to a method for manufacturing LCD image masks that meet flatness requirements of sub-40 μm for part sizes as large as 1220×1400 mm, and even larger as may be needed. While the material presently used for LCD image masks are fused silica and high purity fused silica glass, other glass materials such an ultra-low expansion glass containing 5-10 wt. % TiO₂ doped silica (SiO₂) may offer advantageous material properties for future applications, either existing or new.

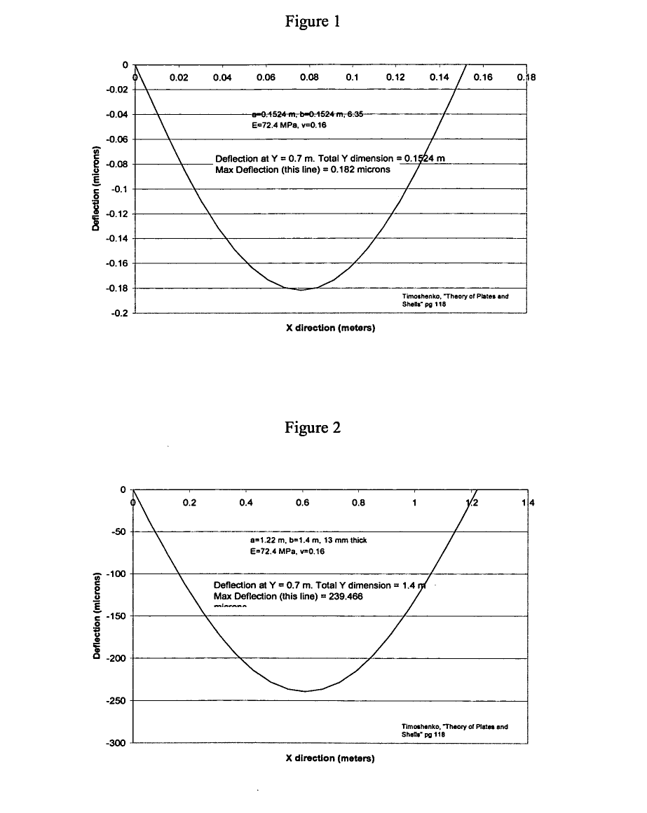

Compared to IC masks, the issue of attaining a flatness specification is confounded by the aspect ratio of the part and the amount of bow or warp the part sees due to its own weight and geometry. For a standard fused silica IC mask with dimensions of 152.4×152.4×6.35 mm, the mask sees a maximum deflection of 0.18 μm when held horizontally by its edges (see FIG. 1). In comparison, a fused silica LCD image mask with dimensions of 1220×1400×13 mm sees a maximum deflection of nearly 240 μm when held in the same manner (see FIG. 2).

For IC masks, attaining a specified flatness in the range of 0.5-1.0 μm is a relatively simple issue of conforming the part to a worktable of equal or higher flatness, and uniformly removing material. The back-side support surface does not need to have the flatness of the worktable due to limited deformation of the part during processing. Any non-uniform surface/subsurface damage and related stresses do not significantly act to deform the part due to its aspect ratio being relatively low and thus being relatively stiff.

However, for the LCD image mask, for example, one with dimensions of 1220×1400×13 mm, the extreme aspect ratio of the mask (140/1 for the foregoing mask having a 1846 mm diagonal) can impact the process of attaining the specified flatness due to deflection of the mask (also called a “part” herein) during grinding, lapping and polishing. If the back-side support surface is non-flat, the part will conform to that surface and uniform material removal will not be achieved no matter how flat the worktable is. As a result of non-uniform material removal, surface/subsurface damage (along with stresses incurred in the part as a result of surface/subsurface damage) are not typically uniform across the part and result in added deformation again due to the fact that the part is so thin that is can bow to alleviate these stresses.

As a result, the standard approach for attaining sub-40 μm flatness for high aspect ratio parts such as LCD image masks is to single-side lap on large planetary tables, allowing the part to rest under its own weight and promoting higher material removal at locations of higher stress (initial contact locations dictated by the part's initial geometry). However, this process is exceedingly slow and offers no means for correction of parts that do not meet specification after initial processing. Conversely, double-side lapping and polishing can be employed but limits attainable flatness due to the part being pressed flat during the use of abrasive materials, subsequently imparting a non-uniform stress across the part to maintain contact with the table, with the lapped/polished surface resulting in “springback” once the part is removed from the table.

The invention at hand relates to the use of sub-aperture deterministic micro-grinding in combination with large-scale interferometric techniques to topographically map and correct bulk flatness for high aspect ratio glass parts. Utilizing the invention, one can obtain final finished flatness of <20 μm and also overcome other difficulties typically encountered in handling large, high aspect ratio parts. For example, traditional grinding/lapping/polishing procedures are exceedingly time consuming for larger parts, offer no opportunity to correct out-of-specification parts, and may not be a manufacturing-sound approach for generating high-aspect ratio parts due to stress-induced warp. The invention overcomes the disadvantages of traditional methods by combining deterministic material removal with high resolution topographical mapping of the work piece.

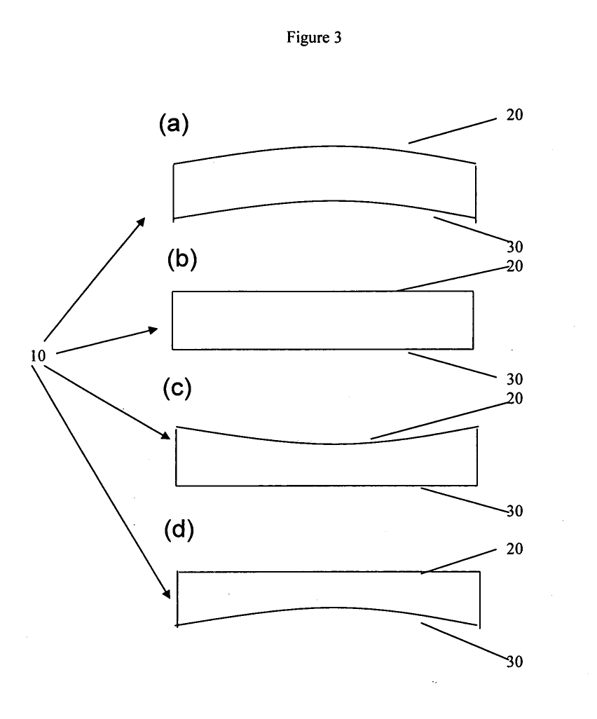

In the first step according to the invention, the LCD image mask having a first or front face 20 and a second or back face 30 (See FIG. 3) is vertically suspended and the first and second faces are interferometrically measured or scanned to obtain a topographical map of each face. The mapping is done in segments and the data, which is stored algorithmically, is stitched together to form an overall “picture” of each face. For example, a 1200×1400 mm LCD image mask may be scanned in overlapping 200×200 mm segments. When the scanning is completed, the segments are numerically stitched together to give a complete picture of the surface. U.S. patent application Ser. No. 11/160,169 (commonly assigned with the present application to Corning Incorporated), filed 15 Jun. 2005, whose teaching are incorporated herein by reference, describes digital image processing, particularly for purposes of optical metrology, in which data sets or segments from multiple images (scans) are combined or stitched together to form a composite image. The process for obtaining this data can be done using commercially available interferometers, preferably computer numerically controlled (“CNC”) interferometers, and their associated software. The LCD image mask (the “workpiece”) is vertically suspended during interferometric scanning in order to obtain a true picture of the defects present on the workpiece and to avoid deflections that may occur during the grinding, lapping and polishing process if the workpiece is laid on a table that is non-flat. By vertically suspending the workpiece during the interferometric procedure one can obtain a true picture of the nature of the imperfections in the surfaces of the mask and they can be removed during the grinding, lapping and polishing procedures. Once the interferometric data has been obtained and stored, the mask is removed from its vertical position and placed on a flat table for performing the grinding, lapping and polishing procedures.

FIGS. 3a-3d are a schematic illustrating LCD image mask 10 processing using a sub-aperture deterministic tool and the interferometric data previously obtained. FIG. 3a is a side view of a LCD image mask with first convex face 20 and second concave face 30. The mask can also have sub-features in addition being concave/convex; for example, micro-bumps, valleys, small surface cracks, and so forth which can be removed or substantially removed using the method of the invention. Using the method of the invention one can remove the concave/convex features of the mask as well as the micro-bumps, valleys, small surface cracks, and so forth that may be present such then when the finished image mask (after grinding, lapping and polishing are completed) is suspended in the vertical position the first and second faces of the mask are flat, having a final flatness of <40 μm, and preferably a flatness of <20 μm. In another embodiment the final flatness is <10 μm.

The side view of FIG. 3a represents the view of the mask when it is in the vertical position for obtaining the interferometric data. FIG. 3b is a side view of the same part laid on a flat table (not illustrated) for performing the grinding/lapping and polishing, and is held in place by its own weight or by other means for holding the mask; for example, the use of vacuum or mechanical means that will not damage the mask. Vacuum is the preferred method. As shown in FIG. 3b, when the mask is placed on the flat table the concave/convex surfaces will “flatten out”. However, if the mask were removed without any processing, the concave/convex features would reappear. Using the interferometric data gathered while the mask in is the vertical position, the faces or surfaces of the mask can be ground, lapped and polished such that both faces have a final finished flatness <40 μm, and preferably a flatness of <20 μm. In another embodiment the final flatness is 10 μm.

Using the interferometric data, the first face 20 of the mask is ground, lapped and polished to a concave shape 20′ as illustrated in FIG. 3c while the mask is being held on the table. When the mask is released from the table, the first face 20 will be flat as illustrated in FIG. 3d. As also illustrated in FIG. 3d the second face 30 retains its concave character because it has not yet been ground, lapped and polished. Once the grinding, lapping and polishing for first face 20 is completed, the mask is turned over such that first face 20 is in contact with the table and then the second face 30 is ground, lapped and polished in a similar manner using the interferometric data. After both faces 20 and 30 have been ground, lapped and polished, the LCD image mask is interferometrically scanned to make certain that the required flatness has been achieved. If it has not, then using the rescanned data the process is repeated as necessary to obtain the final polished product. In an alternative embodiment the first face is interferometrically scanned after it is ground/lapped/polished and before the second face is ground/lapped/polished. The method of the invention thus enables one to re-work a LCD image mask to make a product that meets specification and avoid the necessity of have to discard masks that do not meet specification. Since LCD masks are expensive as are the time and materials required carry out the initial process, this ability to re-work a part results in considerable cost savings.

The grinding, lapping and polishing can be done using methods known in the art and a CNC instrument that utilizes the interferometric data. Such methods include ion milling, magneto-rheological finishing, and deterministic polishing. Deterministic grinding and/or polishing are preferred, including options such as that provided by Zeeko Limited (http:\\//www.zeeko.co.uk/). Articles have appeared in the technical literature describing polishing using the new type of instrumentation such as the Zeeko instruments. Exemplary of this literature include D. D. Walker et al, “The Zeeko/UCL Process for Polishing Large Lenses and Prisms”, Proc. SPIE, Vol. 4411 (2002), pp. 106-111; D. D. Walker et al, “Commissioning of the First Precessions 1.2m CNC Polishing Machines for Large Optics”, Proc. SPIE Vol. 6288 (2006), 62880P-1 to 8. [Paper 62880, pages 1-8); Graham Peggs et al, “Dimensional metrology of mirror segments for extremely-large telescopes”, Proc. SPIE Vol. 5382 (2004), pp. 224-228; D. D. Walker et al, “Recent development of Precessions polishing for larger components and free-form surfaces”, Proc. SPIE Vol. 5523 (20040, pp. 281-289; D. D. Walker et al, “New Results from the Precessions Polishing Process Scaled to Larger Sizes”, Proc. SPIE Vol. 5494 (2004), pp 71-80; and H. Pollicove et al., “Deterministic Manufacturing Processes for precision Optical Surfaces”, Key Engineering Materials Vols. 2383-239 (2003), pp. 533-58.

Deterministic grinding polishing is best described as the use of a CNC tool with a contact head significantly smaller than the workpiece. The tool face can be any traditional polish surface including but not limited to metal, abrasive particles imbedded or otherwise mounted into a metal or resin, polyurethane with or without imbedded abrasive, Teflon, flexible resin-based films with or without imbedded abrasive, or pitch. Abrasive-filled fluids/slurries, water, or other liquids can be used as carrier fluids for removing heat and/or grinding/lapping/polishing debris from the tool/workpiece interface. The surface profile machined into the surface is determined (selected) based on interferometric data recorded during analysis of the given workpiece surface when held in a zero-stress state.

The options for the deterministic polishing step include (but are not limited to) the following technologies, all of which utilize interferometric data to identify highpoints on the work piece requiring removal to attain the desired surface geometry.
1. Magnetorheological finishing (MRF), a technology commercialized by QED Technologies where a slurry of magnetic, spherical iron particles and either CeO2 or diamond abrasives is passed over a sub-aperture magnetic tool where the slurry stiffens and is placed in contact with the work piece. Removal rate is controlled by tool pressure, contact area, and dwell time.
2. Ion milling, a process commercially available through various manufacturers where the work piece surface is exposed to an ion beam (i.e., plasma) that ablates atoms. Removal rate is determined by beam properties, individual atomic bond strength, and localizes stress in the work piece.
3. Deterministic polishing, a process first commercialized by Zeeko Corporation where more traditional polishing consumables such as polyurethane pads and CeO2 abrasives are applied to the work piece surface using a sub-aperture tool where the polishing pad is mounted on a flexible bladder. The abrasive or a coolant is typically sprayed into the tool/work piece contact zone. Bladder pressure and the angle of the tool as applied to the work piece control contact area, with contact area, pressure, rotational speed, etc. control material removal. Pitch and structured polishing pads (such as 3M's Trizac pads) can be utilized as well.

### Deterministic polishing using conventional materials such as in the Zeeko method is preferred.

The invention is also directed to LCD image masks having a length, width and thickness of which the length and width are each, independently of the other, greater than 400 mm and the thickness is less than 20 mm. In one embodiment the length and width is each, independently, greater then 800 mm. In a further embodiment the length and width is each, independently, greater than 1000 mm. In another embodiment the length and width is each, independently, greater then 1200 mm. In further embodiments the thickness of the LCD image mask is less then 15 mm. In additional embodiments the thickness is less than 10 mm. In all the foregoing embodiments the LCD image masks of the invention have final flatness of >40 μm, preferably <20 μm. In yet another embodiment the foregoing LCD image masks have a final flatness of <10 μm. Any glass suitable for LCD image masks can be used in practicing the invention. Preferred glasses are fused silica glass, high purity fused silica glass and silica-titania glass containing 5-10 wt. % titania. An example of high purity fused silica glass is a glass meeting or substantially meeting the specifications of the HPFS® brand high purity fused silica sold by Corning Incorporated.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

We claim:

1. A method for manufacturing very large LCD image masks having a final finished flatness of <40 μm, said method comprising the steps of:
(a) obtaining a glass LCD image mask having a first face and a second face, and mounting the mask in the vertical position;
(b) scanning the first face and the second face of the mask using a computer numerically controlled optical interferometer and storing the data obtained during the scanning in algorithmic form; and
(c) grinding, lapping and polishing the first and/or second faces of the mask using a computer numerically controlled instrument to obtain a LCD image mask have a final finished flatness after polishing of <40 μm.

2. The method according to claim 11, wherein the first and second faces of the LCD image mask are rescanned between the grinding, lapping and polishing of the first face and the grinding, lapping and polishing of the second face.

3. The method according to claim 1, wherein after grinding, lapping and polishing the first and second faces of the LCD image mask, both faces are interferometrically scanned and using this scanned data step 1(c) is repeated as necessary using this rescanned data to obtain a LCD image mask have a final finished flatness after polishing of <40 μm.

4. The method according to claim 1, wherein the grinding and lapping are carried out before the polishing, and said grinding and lapping produce a surface having a flatness in the range of 10-20 μm before polishing.

5. The method according to claim 1, wherein the grinding and lapping are carried out before the polishing, and said grinding and lapping produce a surface having a flatness in the range of 2-10 μm before polishing.

6. The method according to claim 5, wherein after polishing the final finished surface of the mask has a flatness of <20 μm.

7. The method according to claim 5, wherein after polishing the final finished surface of the mask has a flatness of <10 μm.

8. The method according to claim 5, wherein after polishing the final finished surface of the mask has a flatness of <5 μm.

9. The method according to claim 1, wherein said grinding is carried out using a method selected from the group consisting of magneto-rheological, ion milling and aqueous slurry techniques.

10. The method according to claim 1, wherein said glass LCD image mask has a length and a width that are each, independently of the other, greater than 400 mm and a thickness that is less than 20 mm.

11. The method according to claim 1, wherein said glass LCD image mask has a length and a width that are each, independently of the other, greater than 800 mm and a thickness that is less than 15 mm.

12. The method according to claim 1, wherein said glass LCD image mask has a length and a width that are each, independently of the other, greater than 1000 mm and a thickness that is less than 15 mm.

13. The method according to claim 1, wherein said glass LCD image mask has a length and a width that are each, independently of the other, greater than 1200 mm and a thickness that is less then 15 mm.

14. A glass LCD image mask, said mask comprising a selected glass material having a length and a width, each independently of the other being greater than 400 mm, and a thickness of <20 mm,
wherein said glass has a final flatness of <20 μm.

15. The glass LCD image mask according to claim 14, wherein said length and width are each, independently, greater than 800 mm, said thickness is less than 15 mm, and said flatness is less than 20 μm.

16. The glass LCD image mask according to claim 14, wherein said length and width are each, independently, greater than 1000 mm, said thickness is less than 15 mm, and said flatness is less than 10 μm.

17. The glass LCD image mask according to claim 14, wherein said glass is selected from the group consisting of fused silica, high purity fused silica and silica-titania containing 5-10 wt. % titania.

18. A glass LCD image mask, said mask comprising a selected glass material having a length and a width, each independently of the other being greater than 1000 mm, and a thickness of <15 mm, wherein said glass has a final flatness of <10 μm;
wherein said glass is selected from the group consisting of fused silica, high purity fused silica and silica-titania containing 5-10 wt. % titania.

19. The glass LCD image mask according to claim 18, wherein said flatness is <5 μm.
